(19) United States
(12) Patent Application Publication
(10) Pub. No.: US 2015/0028639 A1
(43) Pub. Date: Jan. 29, 2015

(54) LINER WITH BLANKET FOR STROLLERS, CAR SEATS, AND INFANT CARRIERS

(71) Applicant: Simcha Brown, Cedarhurst, NY (US)

(72) Inventor: Simcha Brown, Cedarhurst, NY (US)

(21) Appl. No.: 14/297,613

(22) Filed: Jun. 5, 2014

Related U.S. Application Data
(60) Provisional application No. 61/832,044, filed on Jun. 6, 2013.

(51) Int. Cl. B60N 2/58; A47G 9/02; B62B 9/26; A47C 31/11

(52) U.S. Cl. CPC B60N 2/5816; A47C 31/11; A47G 9/0223; B62B 9/26
USPC 297/184.13

(57) ABSTRACT

A liner for child-carriers may be described and disclosed. Child-carriers may comprise strollers, car-seats, booster-seats, and infant-carriers. The liner may be removably disposed between a child located on top of the liner and the child-carrier. The liner may replace existing cushions on child-carrier. The liner may comprise a cushion, a covering, a first-attachment-means, and a second-attachment-means. The covering may substantially cover the cushion. The covering may comprise an exterior-surface. The exterior-surface may comprise waterproofing and/or windproofing functionality. The first-attachment-means may provide a removable attachment means for attaching the liner to the child-carrier. The second-second-attachment-means may comprise a removable attachment means for attaching a blanket to the liner. The exterior-surface may comprise a blanket-pocket, for removably containing the blanket. The liner may comprise a second blanket, an inner-blanket, that may be removably contained within the blanket-pocket. The blanket may comprise at least one pocket-on-blanket, for removably storage of various articles.

### PRIORITY NOTICE

The present application claims priority under 35 U.S.C. §119(e) to U.S. Provisional Patent Application Ser. No. 61/832,044 filed on Jun. 6, 2013, the disclosure of which is incorporated herein by reference in its entirety.

### STATEMENT REGARDING FEDERAL SPONSORSHIP

No part of this invention was a result of any federally sponsored research.

### TECHNICAL FIELD OF THE INVENTION

The present invention relates to liners of strollers, car-seats, booster-seats, and infant-carriers, wherein the liner may be waterproof and/or windproof. The present invention relates to liners of strollers, car-seats, booster-seats, and infant-carriers, wherein the liner may comprise a means for removable attachment of a blanket to the liner. The present invention relates to liners of strollers, car-seats, booster-seats, and infant-carriers, wherein the liner may comprise a pocket for removably storing blankets and/or rain covers. The present invention relates to liners of strollers, car-seats, booster-seats, and infant-carriers, wherein the liner may comprise blankets and/or rain covers.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

It is well known that infants, and to a lesser degree toddlers, and to a lesser degree small children may require traveling with various objects to facilitate ease of transportation. Such objects may include the physical means for assisting in safe transportation, such as strollers, car-seats (including booster car-seats), and infant-carriers. Additionally because of their small size, they are prone to becoming too cold in even mild weather. Thus, it is often desirable to transport such individuals with various blankets to at a minimum provide some degree of comfort and possibly warmth to these individuals. In addition, these individuals also often travel with various articles, with various children's articles. Such articles may comprise handheld items, i.e. items that may be held in one hand of an infant, toddler, child, or small adult. Such articles may comprise: baby bottles, sippy cups, water bottles, handheld snacks, handheld food, pacifiers, teething toys, handheld toys, handheld books, and the like.

And as any parent, guardian, babysitter, and caregiver can attest to, such individuals routinely drop and/or lose such articles, where in the process of such loss, even if only a temporary loss while driving, translates into frustration, annoyance, and aggravation for the parent, guardian, babysitter, and caregiver.

It is also known that if child-carriers are not protected from the elements, that over time repeated exposure to water and cold temperatures may cause rusting and/or other deterioration problems for the child-carrier, such as facilitating unwanted mildew.

There is need in the art for a liner that may protect the child-carrier from the elements. There is a need in the art for a liner that may replace existing cushions on child-carriers, wherein the new liner may removably attach to the child-carrier and wherein the new cushioned liner comprise a means for removably attaching a blanket to the liner such that the blanket itself does not become easily lost or misplaced. In addition, there is a need in the art for a blanket, as part of the liner, that may provide a means for associating such articles with the blanket, so as to mitigate against such loss.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a liner for child-carriers may be described and disclosed. Child-carriers may comprise strollers, car-seats, booster-seats, and infant-carriers. Such a liner may be removably disposed between a child located on top of the liner and the child-carrier. Such a liner may replace existing cushions on child-carrier. The liner may comprise a cushion, a covering, a first-attachment-means, and a second-attachment-means. The covering may substantially cover the cushion. The covering may comprise an exterior-surface, wherein the exterior-surface may comprise waterproofing and/or windproofing functionality. The first-attachment-means may provide a removable attachment means for attaching the liner to the child-carrier. The second-second-attachment-means may comprise a removable attachment means for attaching a blanket to the liner.

In some embodiments, the exterior-surface may comprise a blanket-pocket, for removably containing (holding) the blanket. In some embodiments, there may be a second blanket, an inner-blanket, that may also be removably contained within the blanket-pocket. In some embodiments, the blanket may comprise at least one pocket-on-blanket, for removably storage of various articles.

Such articles may comprise handheld items, i.e. items that may be held in one hand of an infant, toddler, child, or small adult. Such articles may comprise: baby bottles, sippy cups, water bottles, handheld snacks, handheld food, pacifiers, teething toys, handheld toys, handheld books, and the like. The number of articles held (contained) is limited by a size of the at least one pocket-on-blanket and by a size (e.g. surface area) of the blanket.

It is an objective of the present invention to provide a liner that may removably attach to a stroller, a car-seat (including a booster-seat), and an infant-carrier, such that when in use, the liner may be disposed between the child and the stroller, the car-seat (including the booster-seat), and the infant-carrier.

It is another objective of the present invention to provide a liner that may place existing cushions of the stroller, the car-seat (including the booster-seat), and the infant-carrier.

It is another objective of the present invention to provide a liner that may comprise an external-covering, wherein the external-covering may be windproof and/or waterproof.

It is another objective of the present invention to provide a liner that may comprise an external-covering, wherein the external-covering may comprise a means for removably attaching blankets to the external-covering.

It is another objective of the present invention to provide a liner that may comprise an external-covering, wherein the external-covering may comprise a blanket-pocket, wherein the blanket-pocket may removably hold (i.e. store, contain) a blanket.

It is another objective of the present invention to provide a liner, with the blanket-pocket, wherein the blanket-pocket may comprise the blanket, wherein the blanket may be attached along one edge to the blanket-pocket.

It is another objective of the present invention to provide a blanket that may be used by a user to provide comfort.

It is another objective of the present invention to provide a blanket that may be used by a user to provide warm.

It is another objective of the present invention to provide a blanket that may be used by a user to provide protection from the elements, i.e. the blanket may be waterproof and/or windproof.

It is another objective of the present invention to provide a blanket that may comprise at least one pocket-on-blanket for holding (storing, containing) various articles associated with infants, toddlers, children, and/or small adults.

It is another objective of the present invention to provide a blanket that may comprise at least one pocket-on-blanket that may be integral with the blanket, wherein the at least one pocket-on-blanket may be permanently attached to the blanket.

It is another objective of the present invention to provide a blanket that may comprise at least one pocket-on-blanket that may be removable from the blanket.

It is another objective of the present invention to provide a blanket that may comprise at least one pocket-on-blanket that may be configured as a bottle holder, utilizing elastomeric materials that may frictionally grip the bottle being removably held within the at least one pocket-on-blanket.

It is another objective of the present invention to provide a blanket that may comprise at least one pocket-on-blanket that may be substantially surrounded (bounded) by insulating materials such that the at least one pocket-on-blanket may be an insulated-pocket, wherein the insulated-pocket may protecting articles being removably held within the insulated-pocket from heating and/or cooling too quickly.

It is another objective of the present invention to provide a blanket that may comprise at least one pocket-on-blanket that may further comprise a tethering means (leashing means) for removably attaching an article to the at least one pocket-on-blanket.

It is another objective of the present invention to provide a blanket that may comprise at least one pocket-on-blanket that may further comprise a tethering means (leashing means), wherein the tethering means may removably attach a bottle and/or a pacifier to the at least one pocket-on-blanket.

It is another objective of the present invention to provide a blanket that may comprise at least one pocket-on-blanket that may comprise an opening, wherein the opening may be removably closed (sealed).

It is another objective of the present invention to provide a blanket that may comprise a second-pocket-on-blanket, in addition to the at least one pocket-on-blanket.

It is another objective of the present invention to provide a blanket that may comprise a second-pocket-on-blanket, wherein the second-pocket-on-blanket may be in communication with the at least one pocket-on-blanket.

It is another objective of the present invention to provide a blanket that may comprise a second-pocket-on-blanket, wherein the second-pocket-on-blanket may be disposed between the at least one pocket-on-blanket and an exterior-blanket-surface of the blanket.

It is another objective of the present invention to provide a blanket that may comprise a second-pocket-on-blanket, wherein the second-pocket-on-blanket may be configured to contain (hold, store) at least one handheld toy.

It is yet another objective of the present invention to provide a blanket that may comprise a second-pocket-on-blanket, wherein the second-pocket-on-blanket may comprise a second-tethering means, wherein the second-tethering means may removably attach at least one handheld toy to the second-pocket-on-blanket.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 depicts an exemplary embodiment of a liner, shown from a perspective view.

FIG. 2(a) depicts an exemplary embodiment of a liner comprising a blanket-pocket, shown from a perspective view.

FIG. 2(b) depicts the exemplary embodiment of FIG. 2(a), wherein the blanket-pocket comprises a blanket, shown with the blanket deployed from the blanket-pocket from a perspective view.

FIG. 2(c) depicts the exemplary embodiment of FIG. 2(a), wherein the blanket-pocket comprises two blankets, an outer-blanket and an inner-blanket, shown with both blankets deployed from the blanket-pocket from a perspective view.

FIG. 3 depicts the exemplary embodiment of FIG. 2(a), wherein the blanket-pocket comprises a blanket, wherein the blanket comprises a pocket-on-blanket, shown with the blanket deployed from the blanket-pocket from a perspective view.

FIG. 4 depicts an exemplary embodiment of a rain-cover, wherein the rain-cover may be removably attached to a stroller, wherein rain-cover may be a component of blanket-pocket (not depicted), wherein the blanket-pocket may be a component of a liner (not depicted), shown from a perspective view.

### DETAILED DESCRIPTION OF THE INVENTION

A liner for child-carriers may be described and disclosed. Child-carriers may comprise strollers, car-seats, booster-seats, and infant-carriers. Such a liner may be removably disposed between a child located on top of the liner and the child-carrier. Such a liner may replace existing cushions on child-carrier. The liner may comprise a cushion, a covering, a first-attachment-means, and a second-attachment-means. The covering may substantially cover the cushion. The covering may comprise an exterior-surface, wherein the exterior-surface may comprise waterproofing and/or windproofing functionality. The first-attachment-means may provide a removable attachment means for attaching the liner to the child-carrier. The second-second-attachment-means may comprise a removable attachment means for attaching a blanket to the liner.

In some embodiments, the exterior-surface may comprise a blanket-pocket, for removably containing (holding) the blanket. In some embodiments, there may be a second blanket, an inner-blanket, that may also be removably contained within the blanket-pocket. In some embodiments, the blanket may comprise at least one pocket-on-blanket, for removably storage of various articles.

Such articles may comprise handheld items, i.e. items that may be held in one hand of an infant, a toddler, a child, or a small adult. Such articles may comprise: baby bottles, sippy cups, water bottles, handheld snacks, handheld food, pacifiers, teething toys, handheld toys, handheld books, and the like. The number of articles held (contained) is limited by a size of the at least one pocket-on-blanket and by a size (e.g. surface area) of the blanket.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

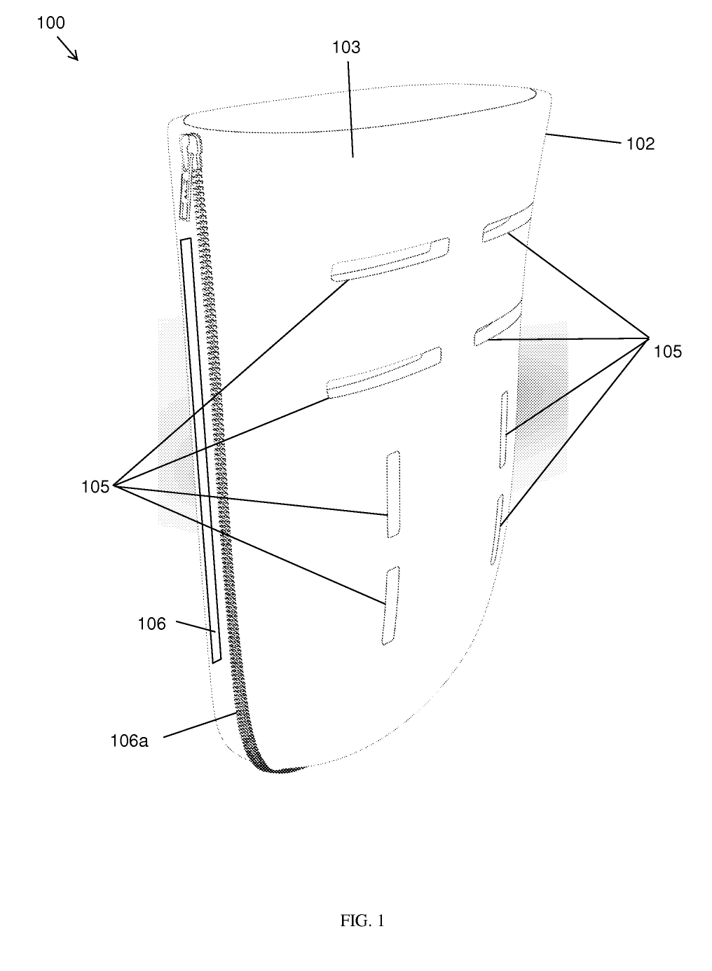

FIG. 1 depicts an exemplary embodiment of a liner 100, shown from a perspective view. In some embodiments, liner 100 may comprise a cushion, a covering 102, a first-attachment-means 105, and a second-attachment-means 106.

The cushion may be configured to provide comfort for the child sitting on top of the cushion. The cushion may be comprised of a foam typically used in the construction of cushions to support infants, toddlers, and children. The cushion may be substantially constructed of a memory foam (e.g. a viscoelastic polyurethane foam, low-resilience polyurethane foam, and the like). The cushion may comprise a three-dimensional shape configured to fit to various models and makes of strollers, car-seats (including booster seats), and infant-carriers. In some embodiments, the cushion may comprise a plurality of cushions. In some embodiments, the cushion may comprise a plurality of foam inserts. Liner 100 (including the cushion), may be removably disposed between the child and the stroller, the car-seat, or the infant-carrier.

Covering 102 may substantially cover the cushion. Covering 102 may comprise an exterior-surface 103 and an interior-surface disposed opposite of exterior-surface 103. The interior-surface may be communication with the cushion. In some embodiments, exterior-surface 103 may be waterproof and/or windproof. In such embodiments, liner 100 may assist in protecting strollers, car-seats, and infant-carriers from the elements.

First-attachment-means 105 may be configured to removably receive harness-hardware of the stroller, the car-seat, or the infant-carrier. The harness-hardware may function to removably secure the child to the stroller, the car-seat, or the infant-carrier. The harness-hardware may be a component of the stroller, the car-seat, or the infant-carrier. The harness-hardware may comprise a pair of shoulder straps, a groin strap, and a locking mechanism for locking the shoulder straps and groin strap together on a tummy side of the child, when the child sits in the to the stroller, the car-seat, or the infant-carrier.

In some embodiments, first-attachment-means 105 may comprise a plurality of holes and/or a plurality of slots. These plurality of holes and the plurality of slots may each pass through the cushion, running from one exterior-surface 103 to a disposed opposite exterior-surface 103 of the covering 102. These plurality of holes and the plurality of slots may be configured to permit removable passage of the harness-hardware through the plurality of holes and/or the plurality of slots.

Second-attachment-means 106 may be configured to permit removable attachment of a blanket (e.g. a blanket 200 to be discussed further below or another blanket) to liner 100. Second-attachment-means 106 may be located substantially along a periphery (e.g. edges) of liner 100. As depicted in FIG. 1, second-attachment-means 106 may run longitudinally along two opposing edges on covering 102. Second-attachment-means 106 may be selected from the group comprising a system of a plurality of hooks and a plurality of complimentary loops (i.e. Velcro®), zippers, snap connectors, buttons, and the like. For example, and without limiting the scope of the present invention, second-attachment-means 106 may comprise alternating regions of plurality of hooks and then plurality of loops along the periphery, such that corresponding complimentary alternating regions of plurality of loop and plurality of hooks located along the edges of the blanket may removably attach to second-attachment-means 106.

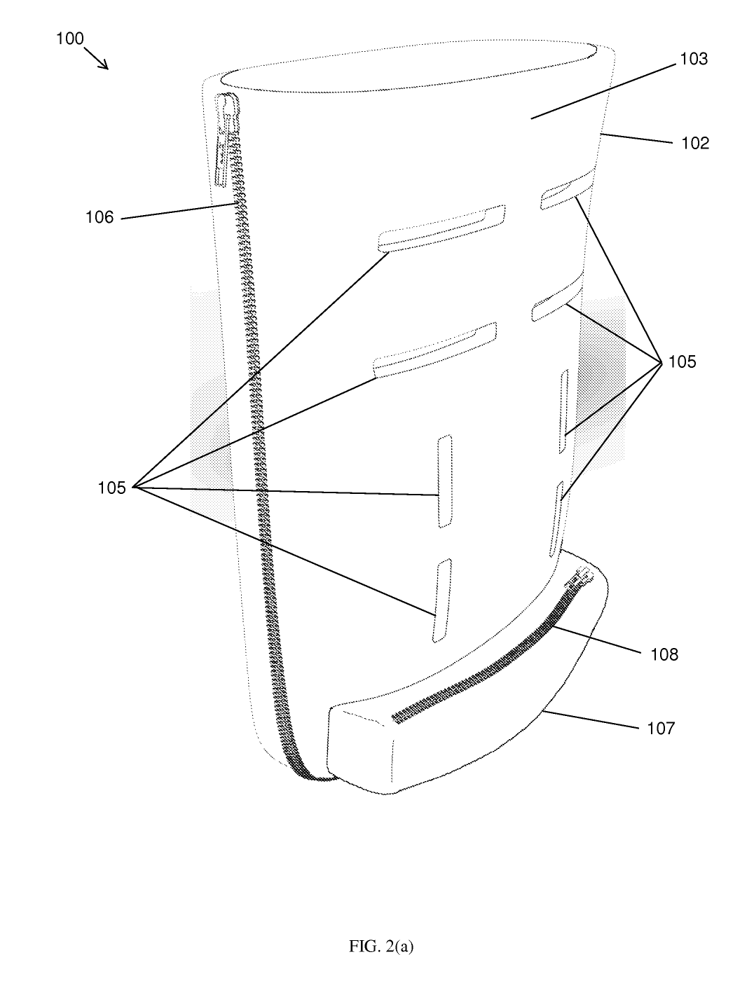

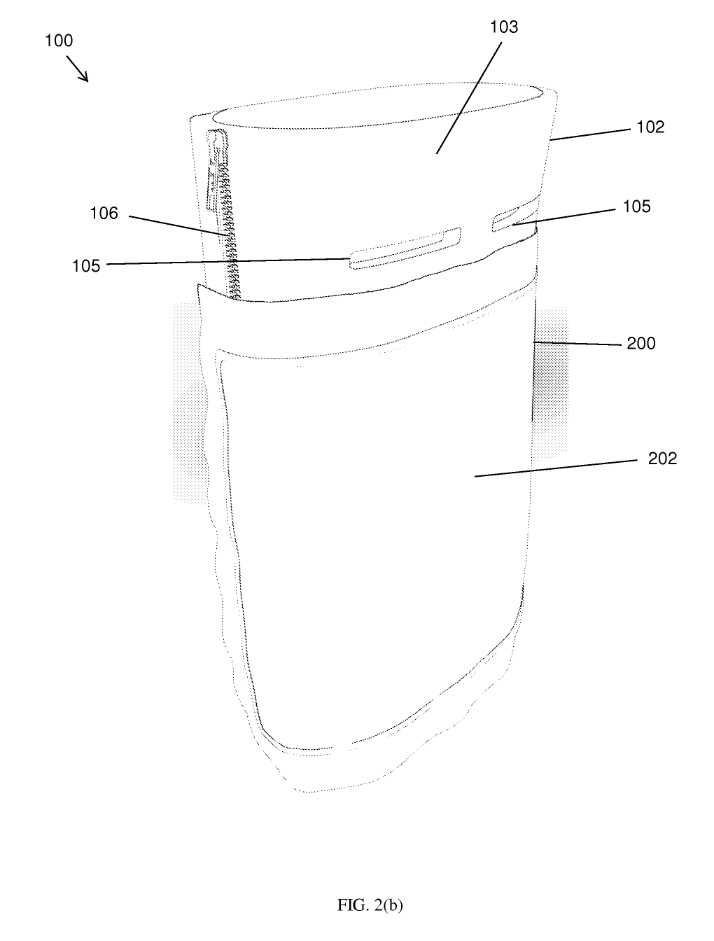

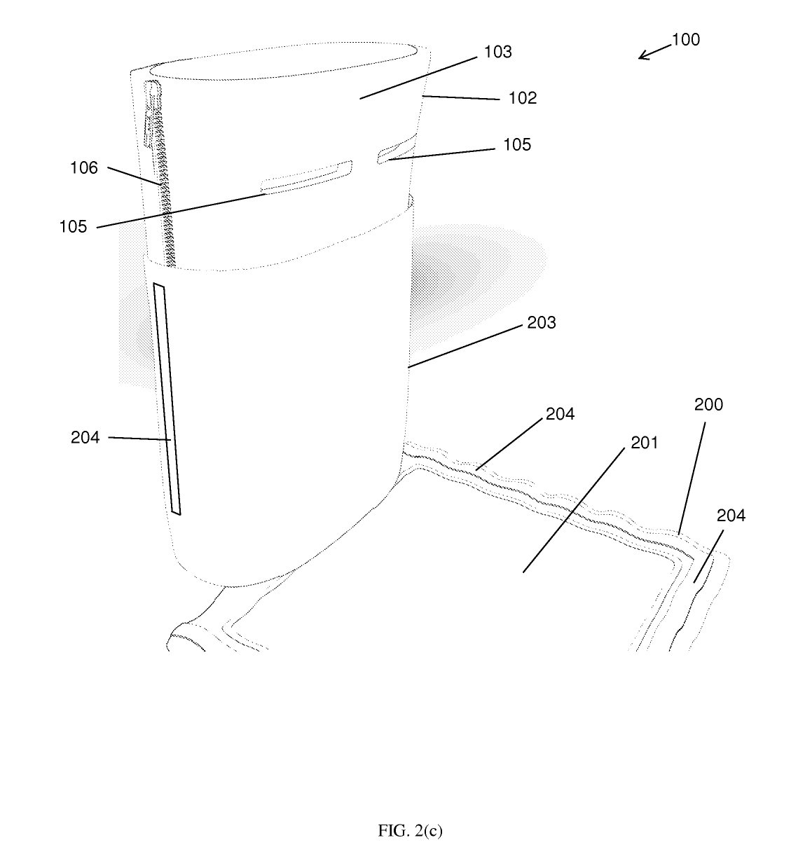

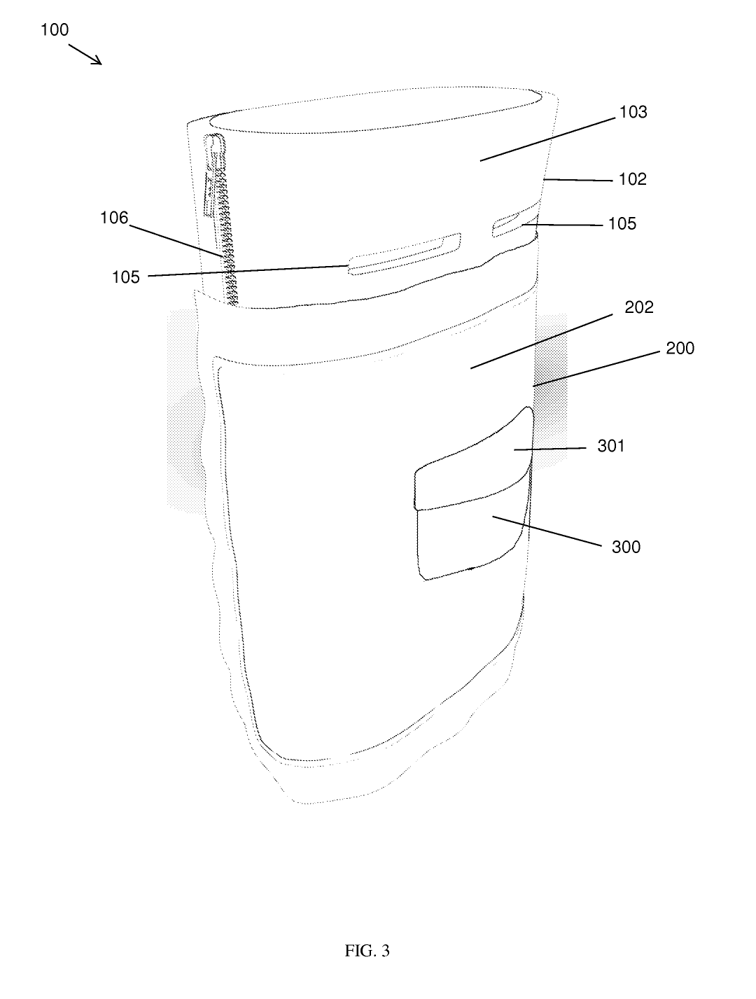

As depicted in FIG. 1, second-attachment-means 106 may comprise a zipper 106a. In the FIG. 2 series of figures and in FIG. 3, such a zipper may be second-attachment-means 106. Such a zipper may run along three edges of covering 102. The blanket may comprise a zipper connection along at least one of its edges, such that this zipper connection (of the blanket) may removably attach to zipper 106a as depicted in FIG. 1, and to zipper 106 in the FIG. 2 series of figures, and FIG. 3. In FIG. 1, the FIG. 2 series of figures, and FIG. 3, second-attachment-means 106 may also comprise regions of Velcro® to a side of zipper 106 and along zipper 106 or to both sides of zipper 106, wherein such Velcro® regions may removably attach to Velcro® regions of one or more blankets.

As depicted in FIG. 1, zipper 106a and zipper 106 in the FIG. 2 series of figures and in FIG. 3, may provide access to an interior of covering 102, to access the cushion (e.g. for cleaning and/or replacing).

FIG. 2(a) depicts an exemplary embodiment of liner 100, wherein liner 100 may comprise a blanket-pocket 107, shown from a perspective view. In some embodiments, exterior-surface 103 may comprise blanket-pocket 107. Blanket-pocket 107 may be one or more pockets. Blanket-pocket 107 may be in communication with exterior-surface 103. In some embodiments, blanket-pocket 107 may be permanently attached to exterior-surface 103. In such embodiments, exterior-surface 103 and blanket-pocket 107 may be a single article of manufacture. In other embodiments, such permanent attachment may be accomplished, depending upon the materials of construction, by stitching, heat welding, ultrasonic welding, solvent bonding, chemical adhesives, and the like.

In some embodiments, blanket-pocket 107 may be removable from exterior-surface 103. In such embodiments, blanket-pocket 107 may be removably attached to exterior-surface 103 by attachment means such as a system of a plurality of hooks and a plurality of complimentary loops (i.e. Velcro®), zippers, snap connectors, buttons, and the like.

Blanket-pocket 107 may comprise a blanket-cavity and a blanket-pocket-opening. The blanket-cavity may be a volume sized to accommodate the blanket (e.g. blanket 200, discussed below). The blanket-pocket-opening may be removably sealable by a blanket-pocket-sealing-means 108. In some embodiments, blanket-pocket-sealing-means 108 may be selected from the group comprising a system of a plurality of hooks and a plurality of complimentary loops (i.e. Velcro®), zippers, snap connectors, buttons, and the like. In some embodiments, blanket-pocket-sealing-means 108 may additionally comprise a flap of material which may removably fold over blanket-pocket-opening.

FIG. 2(b) depicts the exemplary embodiment of FIG. 2(a), wherein blanket-pocket 107 may comprise blanket 200, shown with blanket 200 deployed from blanket-pocket 107, shown from a perspective view. In some embodiments, blanket-pocket 107 may comprise blanket 200. Blanket 200 may be attached to an interior of blanket-pocket 107 along one edge of blanket 200. Blanket 200 may be attached to the interior of blanket-pocket 107 along a portion of one edge of blanket 200. Blanket 200 may be attached to the interior of blanket-pocket 107 by use of a leash. In some embodiments, such an attachment between blanket 200 and the interior of blanket-pocket 107 may be permanent. In such embodiments, such permanent attachment may be accomplished, depending upon the materials of construction, by stitching, heat welding, ultrasonic welding, solvent bonding, chemical adhesives, and the like. In such embodiments, blanket 200 may only be partially removable from blanket-pocket 107, i.e. blanket 200 may be unfolded or unrolled from blanket-pocket 107, such that the child may receive comfort and benefit from blanket 200, but blanket 200 may remain attached along one edge of blanket 200 to the interior of blanket-pocket 107.

In some embodiments, such an attachment between blanket 200 and the interior of blanket-pocket 107 may be removable, i.e. blanket 200 may be removable, completely removable, from blanket-pocket 107. In such embodiments, blanket 200 may be removably attached to blanket-pocket 107 by attachment means such as a system of a plurality of hooks and a plurality of complimentary loops (i.e. Velcro®), zippers, snap connectors, buttons, and the like.

In some embodiments, blanket 200 may comprise an interior-blanket-surface 201 (see FIG. 2(c)) and an exterior-blanket-surface 202 (see FIG. 2(b)) disposed opposite of interior-blanket-surface 201. Interior-blanket-surface 201 may comprise a soft material. It may be intended for interior-blanket-surface 201 to be in removable physical contact with the child to provide warmth and comfort, when blanket 200 may be deployed from blanket-pocket 107. Exterior-blanket-surface 202 may comprise a waterproof and/or a windproof property. Exterior-blanket-surface 202 may comprise a waterproofing material and/or a windproofing material. For example, and without limiting the scope of the present invention, such a material may be Gore-Tex® or a Gore-Tex® like material well known in the art. It may be intended for exterior-blanket-surface 202 to provide protection from the elements to the child, when blanket 200 may be deployed from blanket-pocket 107.

FIG. 2(c) depicts the exemplary embodiment of FIG. 2(a), wherein blanket-pocket 107 may comprise two blankets: an outer-blanket 200 and an inner-blanket 203, shown with both blankets deployed from blanket-pocket 107, and shown from a perspective view. In some embodiments, liner 100 may comprise inner-blanket 203. Inner-blanket 203 may be removably stored within blanket-pocket 107 along with blanket 200. In such embodiments, blanket 200 may be referred to as outer-blanket 200. Inner-blanket 203 and outer-blanket 200 may be two separate blankets. A distinction between “inner” and “outer” as used in this context, may be that outer-blanket 200 may comprise, exterior-blanket-surface 202, wherein exterior-blanket-surface 202 may provide the waterproofing and/or windproofing function to outer-blanket 200 and may thus be the most external (i.e. outer) surface with respect to the child. Whereas, inner-blanket 203 may be in physical contact with the child.

In some embodiments, inner-blanket 203 may comprise a heavier blanket than outer-blanket 200, wherein such heavier characteristics results in inner-blanket 203 providing greater warmth than outer-blanket 200. Embodiments including inner-blanket 203 may be for colder weather environments, where outer-blankets 200 interior-blanket-surface 201 may be not be sufficient to keep the child sufficiently warm.

In some embodiments, inner-blanket 203 may be completely removable from blanket-pocket 107. In some embodiments, inner-blanket 203 may be removably attached to outer-blanket 200 by a blanket-to-blanket-attachment-means 204. Blanket-to-blanket-attachment-means 204 may be selected from the group comprising a system of a plurality of hooks and a plurality of complimentary loops (i.e. Velcro), zippers, snap connectors, buttons and the like. Blanket-to-blanket-attachment-means 204 may be located on an inner-blanket-periphery of the inner-blanket and located on an outer-blanket-periphery of the outer-blanket.

FIG. 3 depicts the exemplary embodiment of FIG. 2(a), wherein blanket-pocket 107 may comprise blanket 200, wherein blanket 200 may comprises a pocket-on-blanket 300, shown with blanket 200 deployed from blanket-pocket 107, and shown from a perspective view. In some embodiments, blanket 200 (including outer-blanket 200) may comprise at least one pocket-on-blanket 300. At least one pocket-on-blanket 300 may be one or more pockets. At least one pocket-on-blanket 300 may comprise: an opening and a cavity. The opening may provide access to the cavity. The cavity may be of a volume configured to contain the various articles, i.e. to removably contain one or more articles. In some embodiments, at least one pocket-on-blanket 300 may be located on exterior-blanket-surface 202 (of blanket 200). In some embodiments, at least one pocket-on-blanket 300 may be located proximally to exterior-blanket-surface 202, separated from exterior-blanket-surface 202 by a second-pocket-on-blanket (not depicted). The second-pocket-on-blanket may be located on exterior-blanket-surface 202. The second-pocket-on-blanket is discussed further after a more detailed discussion of at least one pocket-on-blanket 300.

In some embodiments, there may be a plurality of pockets 300. Such a plurality of pockets 300 may all be located on exterior-blanket-surface 202. A number (quantity) of pockets 300 that may be located on blanket 200 is physically limited by the size of the blanket 200, i.e. by an available surface area of exterior-blanket-surface 202.

In some embodiments, at least one pocket-on-blanket 300 may comprise a closure-means. The closure-means may be configured to removably seal the opening. In some embodiments, the closure-means may be selected from the group comprising Velcro®, Ziploc® type fasteners, zippers, snap connectors, clips, hooks, and the like. In some embodiments, the closure-means may additionally comprise a flap 301 of material which may removably fold over the opening.

In some embodiments, the cavity may comprise a surface-geometry. The surface-geometry may be configured to frictionally grip a bottle, such that the surface-geometry may function as a bottle-holder. The surface-geometry may be formed substantially from an elastomeric-material. In some embodiments, the elastomeric-material may be selected from one or more of the material comprising various foams, gels, rubbers (including natural and/or synthetic), silicones, and the like. Such foam materials may be further selected from one or more of the group comprising: Neoprene®, ethylene vinyl acetate (EVA) polypropylene, polyurethane foams, polystyrene (e.g. Styrofoam®), and the like. In such foam materials, a foam density may be varied by choice of formulation to result in desirable compressibility properties. Likewise, with the non-foam elastomeric-materials (e.g. rubber and/or silicone) durometer may be varied by choice of formulation to result in desirable elastomeric properties.

In some embodiments, at least one pocket-on-blanket 300 may comprise an insulated-pocket. The insulated-pocket may function to slow down heating or cooling of articles held within the cavity. The insulated-pocket may be formed by insulating-materials substantially bounding (i.e. surrounding) the cavity. The insulating-materials may comprise insulation properties. The insulating-materials may comprise materials with low thermal conductivity that may be typical for insulating beverages in cup holders. In some embodiments, the insulating-materials may be selected from one or more of the group comprising EVA foams, polyurethane foams, polystyrene foams (e.g. Styrofoam®), polypropylene foam, and the like. In some embodiments, the insulating-materials may be selected from one or more of the group comprising Neoprene®, gels, and the like.

Alternatively or in addition to, the insulated-pocket that may be formed by structure bounding the cavity, the structure may encapsulate air pockets substantially around the cavity. For example, and without limiting the scope of the present invention, this structure may comprise a plurality of closed cells, wherein each cell encapsulates air. Such a plurality of cells encapsulating air is well known to function as an insulator.

In some embodiments, at least one pocket-on-blanket 300 may comprise at least one contents-tether. The at least one contents-tether may be configured to removably attach articles to the at least one contents-tether. The at least one contents-tether may comprise a tether and a contents-attachment-means.

The tether may comprise a first-terminal-end and a second-terminal-end disposed opposite of the first-terminal-end. The second-terminal-end may be attached to a cavity-surface. The cavity-surface may be an exterior surface of the cavity. The tether may be strapping or cordage. The tether may have elastomeric properties, e.g. resembling Bungee® cord elastomeric properties. In some embodiments, the second-terminal-end may be either permanently attached to the cavity-surface or removably attached to the cavity-surface. For example, and without limiting the scope of the present invention, the second-terminal-end may be attached to the cavity-surface by stitching (e.g. when both the second-terminal-end and the cavity-surface may be fabric type materials), stapling, riveting, ultrasonic welding, heat welding, solvent bonding, chemical adhesive, and the like.

The contents-attachment-means may removably attach articles to the first-terminal-end. The contents-attachment-means may be permanently attached to the first-terminal-end. The contents-attachment-means may be integral with the first-terminal-end.

In some embodiments, the contents-attachment-means may comprise a loop configured to removably attach to the bottle or a clip for removably attaching to a pacifier. In some embodiments, the loop may be a sealed loop with a defined and non-adjustable diameter. In some embodiments, the loop may be the sealed loop, but with an adjustable diameter. In some embodiments, the loop may be openable. In some embodiments, the loop may be either adjustable or non-adjustable. In some embodiments, the clip may be spring loaded.

In some embodiments, blanket 200 may comprise the second-pocket-on-blanket (not depicted). The second-pocket-on-blanket may comprise a second-opening and second-cavity. The second-opening may provide access to the second-cavity. The second-cavity may be of a second-volume configured to contain articles. The second-pocket-on-blanket may be located in communication with at least one pocket-on-blanket 300. In some embodiments, the second-pocket-on-blanket may be disposed between at least one pocket-on-blanket 300 and exterior-blanket-surface 202. In such embodiments, the second-pocket-on-blanket may be an inner-pocket and at least one pocket-on-blanket 300 may be an external-pocket.

In some embodiments, the second-pocket-on-blanket may comprise a second-closure-means. The second-closure-means may be configured to removably seal the second-opening. In some embodiments, the second-closure-means may be selected from the group comprising Velcro®, Ziploc® type fasteners, zippers, snap connectors, clips, hooks, and the like. In some embodiments, the second-closure-means may additionally comprise a flap of material which may removably fold over the second-opening.

In some embodiments, the second-pocket-on-blanket may comprise at least one second-contents-tether. The at least one second-contents-tether may be configured to removably attach articles to the at least one second-contents-tether. The at least one second-contents-tether may comprise a second-tether and a second-contents-attachment-means. The second-tether may comprise a third-terminal-end and a fourth-terminal-end disposed opposite of the third-terminal-end. The fourth-terminal-end may be attached to a second-cavity-surface. The second-cavity-surface may be an exterior surface of the second-cavity, residing within the second-cavity. The second-contents-attachment-means may removably attach articles to the third-terminal-end.

The second-tether may be strapping or cordage. The second-tether may have elastomeric properties, e.g. resembling Bungee® cord elastomeric properties. In some embodiments, the fourth-terminal-end may be either permanently attached to the second-cavity-surface or removably attached to the second-cavity-surface. For example, and without limiting the scope of the present invention, the fourth-terminal-end may be attached to the second-cavity-surface by stitching (e.g. when both the fourth-terminal-end and the second-cavity-surface may be fabric type materials), stapling, riveting, ultrasonic welding, heat welding, solvent bonding, chemical adhesive, and the like.

In some embodiments, the second-contents-attachment-means may be configured to removably attach to one or more articles, wherein articles may be are handheld toys. For example and without limiting the scope of the present invention, the second-contents-attachment-means may comprise a ring with a plurality of clips attached to the ring. Each clip of the plurality of clips may removably attach to a given handheld toy. The ring may also be attached to the third-terminal-end. In such embodiments, a single second-contents-attachment-means may removably attach to the plurality of handheld toys.

Regarding attaching at least one pocket-on-blanket 300 and/or the second-pocket-on-blanket to exterior-blanket-surface 202, and/or attaching at least one pocket-on-blanket 300 to the second-pocket-on-blanket, such attachment means may be permanent. In some embodiments, such attachment means may be by stitching, stapling, riveting, ultrasonic welding, heat welding, solvent bonding, chemical adhesive (e.g. gluing), and the like. Obviously, one of ordinary skill in the art will appreciate that some attachment means may be dependent upon the underlying materials of construction to be joined. For example, and without limiting the scope of the present invention, some of the above named attachment means (e.g. ultrasonic welding and solvent bonding) may be more suitable for joining two plastic (or synthetic) materials and not appropriate for joining two or more pieces of cotton fabric.

Regarding attaching at least one pocket-on-blanket 300 and/or the second-pocket-on-blanket to exterior-blanket-surface 202, and/or attaching at least one pocket-on-blanket 300 to the second-pocket-on-blanket, such attachment means may be removable. In some embodiments, such attachment means may be by Velcro®, zippers, snap connectors, buttons, and the like.

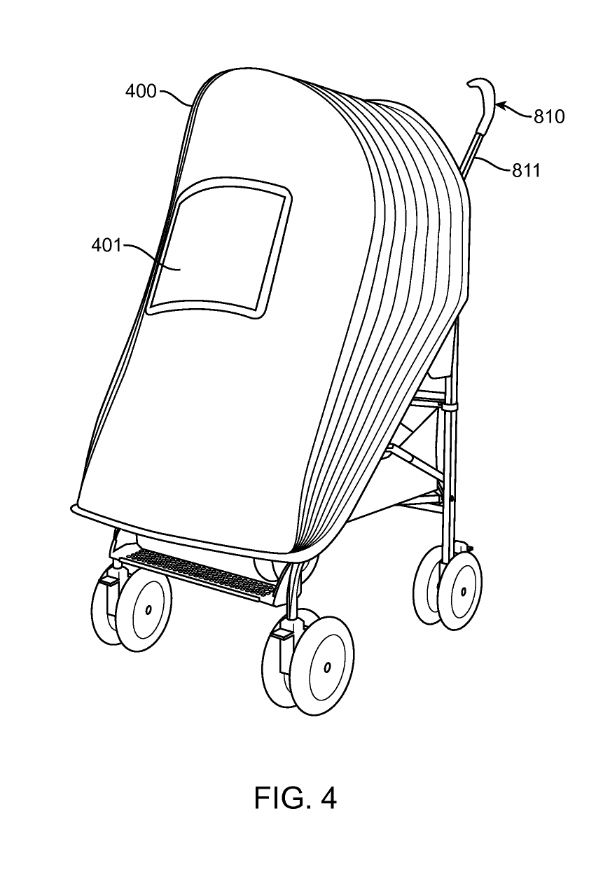

FIG. 4 depicts an exemplary embodiment of a rain-cover 400, wherein train-cover 400 may be removably attached to a stroller 810, shown from a perspective view. Rain-cover 400 may be a component of blanket-pocket 107 (not depicted in FIG. 4). Blanket-pocket 107 may be a component of liner 100 (not depicted in FIG. 4).

In some embodiments, rain-cover 400 may be removably stored (contained) within blanket-pocket 107. When deployed, rain-cover 400 may be configured to removably and substantially cover stroller 810 or a child-carrier (e.g. an infant-carrier). Rain-cover 400 may function to protect stroller 810 or the child-carrier from the elements (e.g. from rain, snow, sleet, sunlight, and/or wind), including protecting a user (occupant or rider) of stroller 810 or the child-carrier. In some embodiments rain-cover 400 may be substantially constructed of a waterproof and/or a windproof material, such as Gore-Tex®.

In some embodiments, rain-cover 400 may comprise an edge-attachment-means. The edge-attachment-means may be located along a peripheral edges of rain-cover 400. In some embodiments, each edge-attachment means may be configured to removably attach to a frame-member 811 of stroller 810 or to removably attach to the child-carrier (not depicted). Removable attachment of rain-cover 400 to stroller 810 may be such that the user riding within stroller 810 (or the child-carrier) may receive the benefits of rain-cover 400, i.e. rain-cover 400 may substantially cover the user and stroller 810. In some embodiments, the edge-attachment-means may be selected from one or more of the group comprising hooks, bungees with connectors, Velcro®, zippers, snap connectors, buttons, and the like. In some embodiments, the edge-attachment-means may also be located on terminal ends of straps, wherein the other end may be attached to the peripheral edges of rain-cover 400. For example, and without limiting the scope of the present invention, the edge-attachment-means may comprise a plurality of hooks wherein each hook may be configured to removably clip onto frame-member 811. For example, and without limiting the scope of the present invention, the edge-attachment-means may comprise a plurality of short straps comprising Velcro®, wherein each short strap may be configured to wrap around frame-member 811 such that each short strap may Velcro® to itself. In such embodiments, the short straps may be less than six inches in length. In some embodiments, the straps may be adjustable.

In some embodiments, rain-cover 400 may comprise a window 401. Window 401 may be configured such the user (occupant) may be able to see through window 401. Window 401 may be substantially constructed of a transparent material, such as a transparent plastic.

In some embodiments, rain-cover 400 may be replaced with blanket 200 comprising waterproof and/or windproof exterior-blanket-surface 202 and wherein blanket-to-blanket-attachment-means 204 may be configured to removably attach to frame-members 811 of stroller 810.

In some embodiments, covering 102 may be substantially constructed of various fabrics. Such fabrics may be typical of the materials ordinarily used to in manufacturing of coverings for liners of stroller, car-seat (including booster seats), and infant-carrier cushions. Such fabrics may be soft. Such fabrics may be selected from natural and/or synthetic materials. For example, and without limiting the scope of the present invention, natural materials may be selected from one or more of the group comprising cotton, silk, wool, linen, hemp, leather, and the like. For example, and without limiting the scope of the present invention, synthetic materials may be selected from one or more of the group comprising polypropylene, polyester, acrylic, nylon, rayon, acetate, spandex, and the like. In some embodiments exterior-surface 103 may be constructed of a waterproof and/or a windproof material, such as Gore-Tex®.

In some embodiments, blanket 200 (including outer-blanket 200) and inner-blanket 203 may be substantially constructed of various fabrics, wherein the resulting blanket 200 and inner-blanket 203 may function to provide comfort, warmth, and/or protection from the elements to the user of blanket 200 and inner-blanket 203. Such fabrics may be typical of the materials ordinarily used to in manufacturing blankets for infants, toddlers, and/or small children. Such fabrics may be soft. Such fabrics may be selected from natural and/or synthetic materials. For example, and without limiting the scope of the present invention, natural materials may be selected from one or more of the group comprising cotton, silk, wool, linen, hemp, leather, and the like. For example, and without limiting the scope of the present invention, synthetic materials may be selected from one or more of the group comprising polypropylene, polyester, acrylic, nylon, rayon, acetate, spandex, and the like. In some embodiments exterior-blanket-surface 202 may be constructed of a waterproof and/or a windproof material, such as Gore-Tex®.

With respect to use of “substantially,” in the above paragraph, note blanket 200 and inner-blanket 203 may comprise other materials. For example, in some embodiments, metals may be employed in the various fastener and attachment means, e.g. with zippers. For example, in some embodiments, foams may be employed in blanket 200 embodiments which may comprise the insulated-pocket. For example, in some embodiments, various elastomers may be employed in blanket 200 embodiments which may comprise the bottle-holder to form fit and frictionally grip the bottle.

Note with respect to the materials of construction disclosed herein, it is not desired nor intended to thereby unnecessarily limit the present invention by reason of such restricted disclosure.

A liner for strollers, car-seats (including booster seats), and infant-carriers has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A liner for a stroller, a car-seat, and an infant-carrier, wherein the liner comprises:
a cushion, wherein the cushion is configured to provide comfort for a child sitting on top of the cushion;
a covering, wherein the covering substantially covers the cushion, wherein the covering comprises an exterior-surface and an interior-surface disposed opposite of the exterior-surface, wherein the interior-surface is in communication with the cushion;
a first-attachment-means, wherein the first-attachment-means is configured to removably receive harness-hardware of the stroller, the car-seat, or the infant-carrier, wherein the harness-hardware functions to removably secure the child to the stroller, the car-seat, or the infant-carrier; and
a second-attachment-means, wherein the second-attachment-means is configured to permit removable attachment of a blanket to the liner, wherein the second-attachment-means is located substantially along a periphery of the liner;
wherein the liner is removably disposed between the child and the stroller, the car-seat, or the infant-carrier.

2. The liner according to claim 1, wherein the first-attachment-means comprises a plurality of holes and/or a plurality of slots, wherein the plurality of holes and the plurality of slots each passes through the cushion, running from one exterior-surface to a disposed opposite exterior-surface of the covering, wherein the plurality of holes and the plurality of slots are configured to permit removable passage of the harness-hardware through the plurality of holes and/or the plurality of slots.

3. The liner according to claim 1, wherein the exterior-surface is waterproof and/or windproof.

4. The liner according to claim 1, wherein the exterior-surface comprises a blanket-pocket, wherein the blanket-pocket is in communication with the exterior-surface, wherein the blanket-pocket comprises a blanket-cavity and a blanket-pocket-opening, wherein the blanket-cavity is a volume sized to accommodate the blanket, and wherein the blanket-pocket-opening is removably sealable by a blanket-pocket-sealing-means.

5. The liner according to claim 4, wherein the blanket-pocket-sealing-means is selected from the group consisting of a system of a plurality of hooks and a plurality of complimentary loops, zippers, snap connectors and buttons.

6. The liner according to claim 4, wherein the blanket-pocket comprises the blanket, wherein the blanket is attached to an interior of the blanket-pocket along one edge of the blanket.

7. The liner according to claim 6, wherein the blanket comprises an interior-blanket-surface and an exterior-blanket-surface disposed opposite of the interior-blanket-surface, wherein the interior-blanket-surface comprises a soft material, wherein the exterior-blanket-surface comprises a waterproof and/or a windproof property.

8. The liner according to claim 6, wherein the liner comprises an inner-blanket, wherein the inner-blanket is removably stored within the blanket-pocket, wherein the blanket is an outer-blanket.

9. The liner according to claim 8, wherein the inner-blanket is completely removable from the blanket-pocket.

10. The liner according to claim 8, wherein the inner-blanket is removably attached to the outer-blanket by a blanket-to-blanket-attachment-means.

11. The liner according to claim 10, wherein the blanket-to-blanket-attachment-means is selected from the group consisting of a system of a plurality of hooks and a plurality of complimentary loops, zippers, snap connectors and buttons; wherein the blanket-to-blanket-attachment-means is located on an inner-blanket-periphery of the inner-blanket and located on an outer-blanket-periphery of the outer-blanket.

12. The liner according to claim 7, wherein the blanket comprises:
at least one pocket-on-blanket, wherein the at least one pocket-on-blanket comprises an opening to a cavity, wherein the cavity is of a volume configured to contain various articles;
wherein the at least one pocket-on-blanket is located on either the exterior-surface or located proximally to the exterior-surface, separated from the exterior-surface by a second-pocket-on-blanket which is located on the exterior-surface.

13. The liner according to claim 12, wherein the cavity comprises a surface-geometry configured to frictionally grip a bottle, such that the surface-geometry functions as a bottle-holder.

14. The liner according to claim 13, wherein the surface-geometry is formed substantially from an elastomeric-material.

15. The liner according to claim 12, wherein the at least one pocket-on-blanket comprises an insulated-pocket, wherein the insulated-pocket is formed by insulating-materials substantially bounding the cavity, wherein the insulating-materials comprise insulation properties.

16. The liner according to claim 12, wherein the at least one pocket-on-blanket comprises at least one contents-tether, wherein the at least one contents-tether is configured to removably attach the article to the at least one contents-tether, wherein the at least one contents-tether comprises:
a tether, wherein the tether comprises a first-terminal-end and a second-terminal-end disposed opposite of the first-terminal-end, wherein the second-terminal-end is attached to a cavity-surface, wherein the cavity-surface is an exterior surface of the cavity;
a contents-attachment-means, wherein the contents-attachment-means removably attaches the article to the first-terminal-end.

17. The liner according to claim 16, wherein the contents-attachment-means is a loop configured to removably attach to a bottle or a clip for removably attaching to a pacifier.

18. The liner according to claim 12, wherein the blanket comprises a second-pocket-on-blanket, wherein the second-pocket-on-blanket comprises a second-opening to a second-cavity, wherein the second-cavity is of a second-volume configured to contain various articles, wherein the second-pocket-on-blanket is located in communication with the at least one pocket-on-blanket.

19. The liner according to claim 18, wherein the second-pocket-on-blanket is disposed between the at least one pocket-on-blanket and one of the exterior-surfaces of the two-surfaces, such that the second-pocket-on-blanket is an inner-pocket and the at least one pocket-on-blanket is an external-pocket.

20. The liner according to claim 18, wherein the second-pocket-on-blanket comprises at least one second-contents-tether, wherein the at least one second-contents-tether is configured to removably attach the article to the at least one second-contents-tether, wherein the at least one second-contents-tether comprises:
a second-tether, wherein the second-tether comprises a third-terminal-end and a fourth-terminal-end disposed opposite of the third-terminal-end, wherein the fourth-terminal-end is attached to a second-cavity-surface, wherein the second-cavity-surface is an exterior surface of the second-cavity;
a second-contents-attachment-means, wherein the second-contents-attachment-means removably attaches the article to the third-terminal-end.
